(19) United States
(12) Patent Application Publication
(10) Pub. No.: US 2026/0085978 A1
(43) Pub. Date: Mar. 26, 2026

(54) TEMPERATURE DETECTION MODULE, TERMINAL ASSEMBLY AND CHARGING DEVICE

(71) Applicants: Tyco Electronics (Suzhou) Ltd., Suzhou City (CN); Tyco Electronics (Shanghai) Co., Ltd., Shanghai (CN); Tyco Electronics Technology (SIP) Co., Ltd., Suzhou (CN)

(72) Inventors: Jinshun (Jet) Wang, Suzhou (CN); Fangyue (Jason) Zhu, Shanghai (CN); Renyi (Ronny) Dou, Suzhou (CN); Leilei Xia, Shanghai (CN)

(73) Assignees: Tyco Electronics (Suzhou) Ltd., Suzhou City (CN); Tyco Electronics (Shanghai) Co., Ltd., Shanghai (CN); Tyco Electronics Technology (SIP) Co., Ltd., Suzhou (CN)

(21) Appl. No.: 19/339,395

(22) Filed: Sep. 25, 2025

(30) Foreign Application Priority Data
Sep. 25, 2024 (CN) 202411350996.9

(51) Int. Cl. G01K 1/143; G01K 1/14; H01R 13/66

(52) U.S. Cl. CPC G01K 1/143; G01K 1/146; H01R 13/6683

(57) ABSTRACT

A temperature detection module includes a terminal locking component lockable to a charging terminal and insertable into a mounting hole of a housing of a charging device together with the charging terminal. The terminal locking component locks the charging terminal into the housing. A temperature sensor is installed in the terminal locking component and inserted into the mounting hole of the housing together with the terminal locking component. The temperature sensor detects a temperature of the charging terminal.

### CROSS-REFERENCE TO RELATED APPLICATION

This application claims the benefit of the filing date under 35 U.S.C. § 119(a)-(d) of Chinese Patent Application No. 202411350996.9, filed on Sep. 25, 2024.

### FIELD OF THE INVENTION

The present invention relates to a temperature detection module, a terminal assembly comprising the temperature detection module, and a charging device comprising the terminal assembly.

### BACKGROUND OF THE INVENTION

In order to charge the battery pack of new energy electric vehicles, it is necessary to install a charging dock suitable for mating with a charging gun on the new energy electric vehicle. In order to improve charging speed, it is necessary to increase the charging current. Currently, the charging current is as high as 600 A, and it may even increase to 1000 A in the future. When a large current flows through the charging terminals inside the charging dock, a large amount of heat is generated, which can cause the temperature of the charging terminals inside the charging dock to rise sharply. If the temperature rise cannot be controlled in time, it can lead to safety accidents, such as burning the charging dock or other electrical equipment.

In order to control the temperature rise of the charging terminal, a lead frame is usually installed in the charging dock and a temperature detector is mounted on the lead frame. The temperature detector includes a temperature sensor and a thermal pad wrapped around the outside of the temperature sensor. The thermal pad is in thermal contact with the charging terminal, and the temperature sensor is electrically connected to the lead frame. The installation structure of existing temperature detectors is very complex, costly, and inconvenient to use.

### SUMMARY OF THE INVENTION

A temperature detection module includes a terminal locking component lockable to a charging terminal and insertable into a mounting hole of a housing of a charging device together with the charging terminal. The terminal locking component locks the charging terminal into the housing. A temperature sensor is installed in the terminal locking component and inserted into the mounting hole of the housing together with the terminal locking component. The temperature sensor detects a temperature of the charging terminal.

### BRIEF DESCRIPTION OF THE DRAWINGS

Features of the present invention will become more apparent by describing in detail exemplary embodiments thereof with reference to the accompanying drawings, in which:

FIG. 1 shows an illustrative perspective view of a terminal assembly according to a first embodiment of the present invention;

FIG. 2 shows an illustrative exploded view of the terminal assembly according to the first embodiment of the present invention;

FIG. 3 shows a cross-sectional view of the terminal assembly according to the first embodiment of the present invention;

FIG. 4 shows an exploded sectional view of the terminal assembly according to the first embodiment of the present invention;

FIG. 5 shows an illustrative perspective view of the temperature detection module according to the first embodiment of the present invention when viewed from one side;

FIG. 6 shows an illustrative perspective view of the temperature detection module according to the first embodiment of the present invention when viewed from the other side;

FIG. 7 shows an illustrative perspective view of the terminal locking component of the temperature detection module according to the first embodiment of the present invention;

FIG. 8 shows a cross-sectional view of a temperature detection module according to the first embodiment of the present invention;

FIG. 9 shows a sectional view of the charging device according to the first embodiment of the present invention;

FIG. 10 shows another cross-sectional view of the charging device according to the first embodiment of the present invention;

FIG. 11 shows an illustrative perspective view of a terminal assembly according to a second embodiment of the present invention;

FIG. 12 shows an illustrative exploded view of the terminal assembly according to the second embodiment of the present invention;

FIG. 13 shows a cross-sectional view of a terminal assembly according to a second embodiment of the present invention;

FIG. 14 shows an exploded sectional view of a terminal assembly according to a second embodiment of the present invention;

FIG. 15 shows an illustrative perspective view of a temperature detection module according to a second embodiment of the present invention;

FIG. 16 shows an illustrative exploded view of a temperature detection module according to a second embodiment of the present invention;

FIG. 17 shows a cross-sectional view of a temperature detection module according to a second embodiment of the present invention;

FIG. 18 shows an illustrative exploded view of the charging device according to the second embodiment of the present invention; and

FIG. 19 shows an illustrative assembly view of the charging device according to the second embodiment of the present invention.

### DETAILED DESCRIPTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

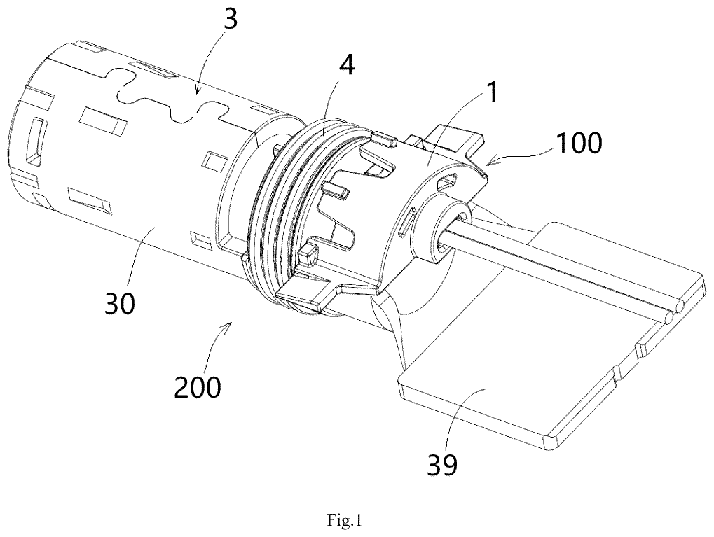

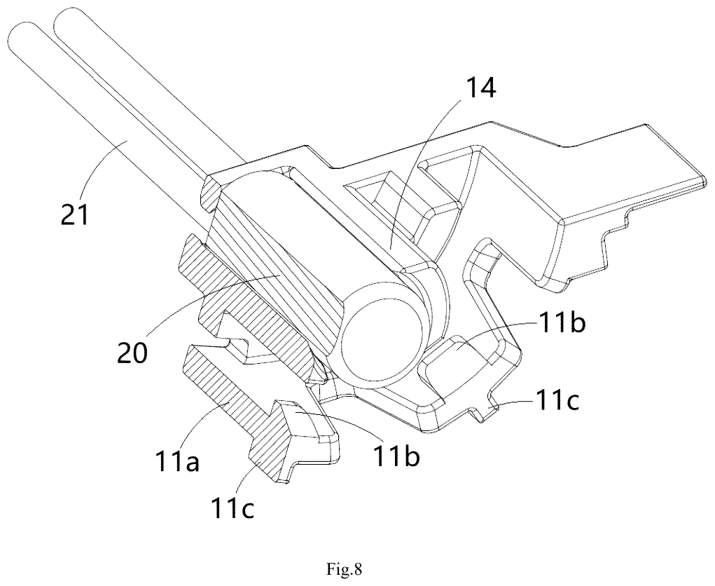

As shown in FIGS. 1 to 10, in an exemplary embodiment of the present invention, a temperature detection module 100 is disclosed. The temperature detection module 100 includes a terminal locking component 1 and a temperature sensor 2. The terminal locking component 1 is suitable for being installed and locked to the charging terminal 3 and for being inserted into the mounting hole 60 of the housing 6 of the charging device together with the charging terminal 3, for locking the charging terminal 3 into the housing 6. The temperature sensor 2 is installed in the terminal locking component 1 and is suitable for being inserted into the mounting hole 60 of the housing 6 together with the terminal locking component 1, for detecting the temperature of the charging terminal 3. In an embodiment, the terminal locking component 1 can be an integral injection molded part.

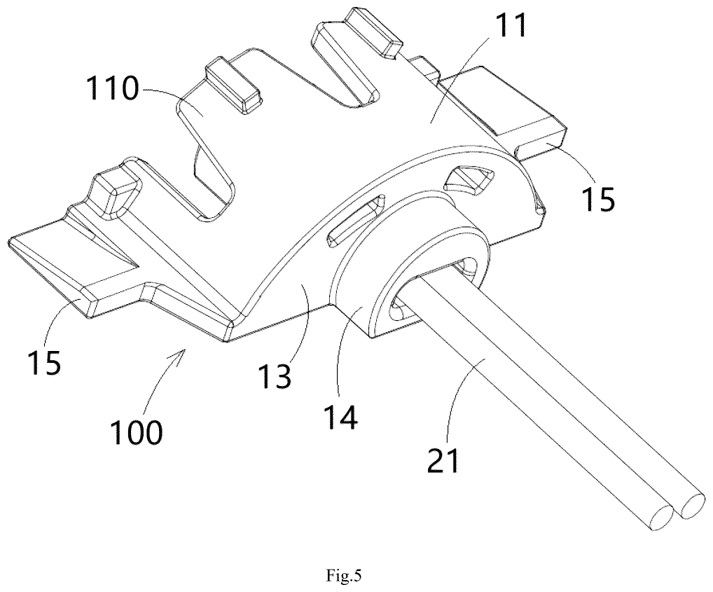

As shown in FIG. 5, in the illustrated embodiment, an elastic locking buckle 15 is formed on the terminal locking component 1, and the terminal locking component 1 is adapted to be locked into the housing 6 of the charging device through the elastic locking buckle 15.

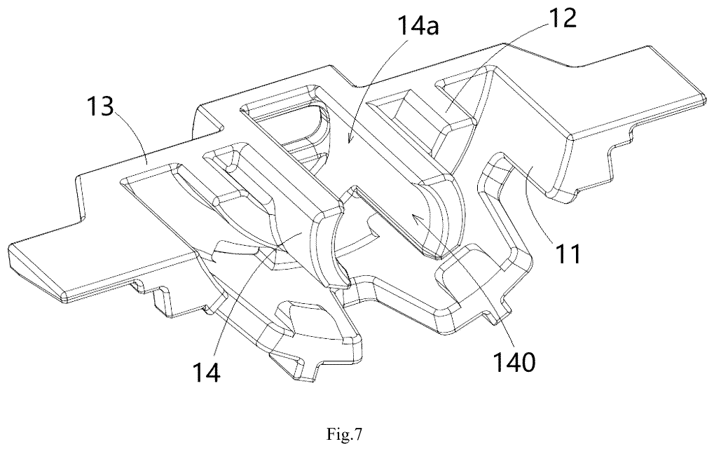

As shown in FIG. 7, in the illustrated embodiment, an installation groove 140 is formed on the terminal locking component 1, and the body 20 of the temperature sensor 2 is installed in the installation groove 140. A pair of leads 21 of the temperature sensor 2 are led out from the terminal locking component 1.

As shown in FIGS. 1 to 10, in another exemplary embodiment of the present invention, a terminal assembly 200 is also disclosed. The terminal assembly 200 includes a charging terminal 3 and the aforementioned temperature detection module 100. The terminal locking component 1 of the temperature detection module 100 is installed and locked to the charging terminal 3. The terminal assembly 200 is suitable for being inserted into the mounting hole 60 in the housing 6 of the charging device, and the terminal locking component 1 is suitable for being fixed to the housing 6 to lock the charging terminal 3 in the housing 6. In the illustrated embodiment, the charging terminal 3 is an integral stamped terminal.

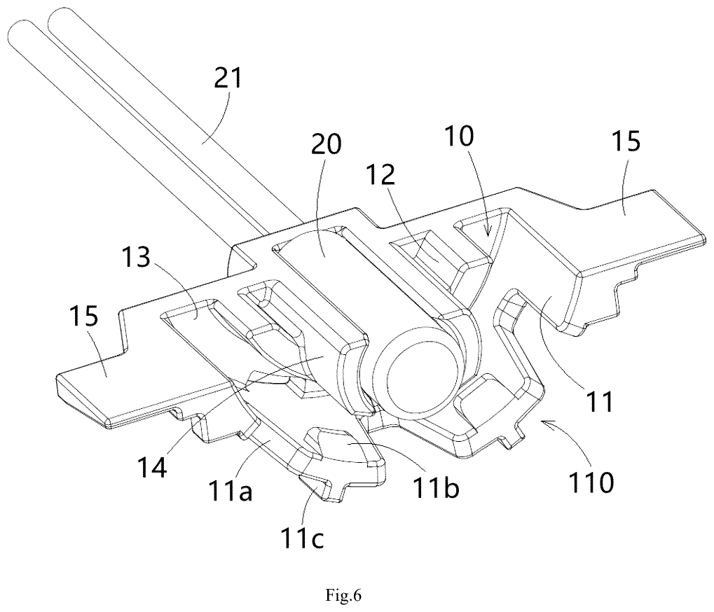

As shown in FIGS. 1 and 6, in the illustrated embodiment, the charging terminal 3 includes a hollow cylindrical body 30, and an arc-shaped slot 10 is formed on the terminal locking component 1. A part of the peripheral wall of the rear end of the cylindrical body 30 is inserted into the arc-shaped slot 10 of the terminal locking component 1.

As shown in FIGS. 5 and 6, in the illustrated embodiment, the terminal locking component 1 includes an outer arc-shaped wall 11 and an inner arc-shaped wall 12 for defining the arc-shaped slot 10. The outer arc-shaped wall 11 and the inner arc-shaped wall 12 respectively abut against the outer and inner circumferential surfaces of a portion of the circumferential wall at the rear end of the cylindrical body 30.

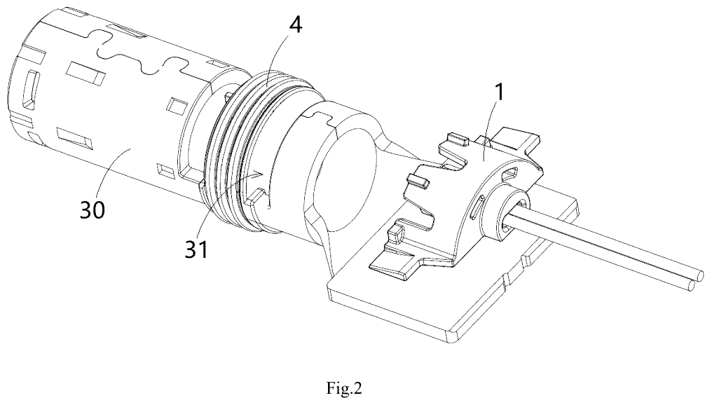

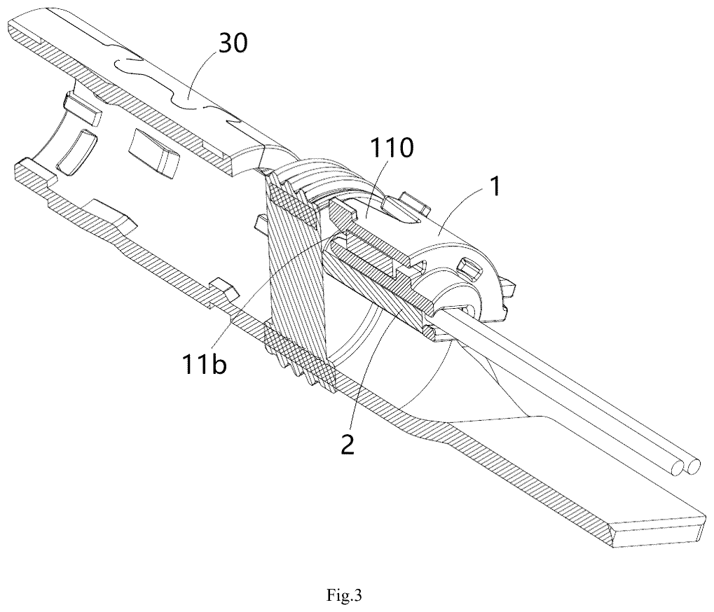

As shown in FIGS. 2 and 3, in the illustrated embodiment, an arc-shaped slot hole 31 is formed in the peripheral wall of the rear end of the cylindrical body 30 of the charging terminal 3, and an elastic buckle 110 is formed on the outer arc-shaped wall 11 of the terminal locking component 1. The elastic buckle 110 is engaged with the rear edge portion 31b of the arc-shaped slot hole 31 to lock the terminal locking component 1 to the cylindrical body 30 of the charging terminal 3.

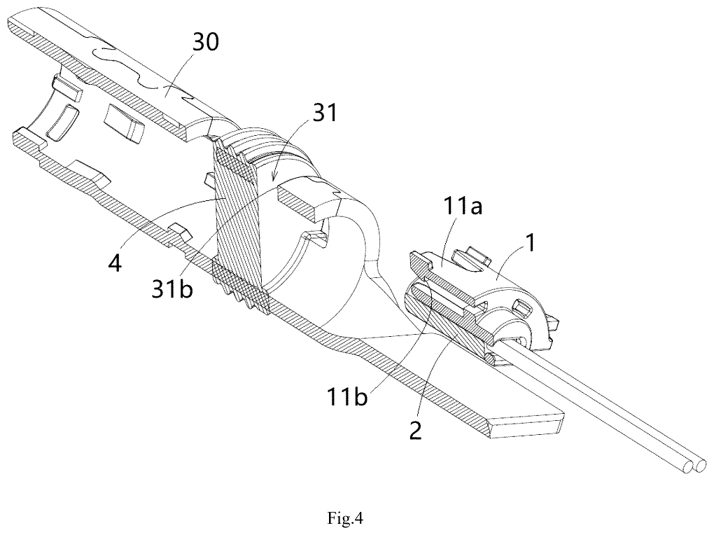

As shown in FIGS. 3 and 4, in the illustrated embodiment, the elastic buckle 110 includes a cantilever portion 11a and a protruding portion 11b. The cantilever portion 11a is connected to the outer arc-shaped wall 11. The protruding portion 11b is formed on the inner side of the end of the cantilever 11a. The protruding portion 11b of the elastic buckle 110 is engaged with the rear edge portion 31b of the arc-shaped slot hole 31 in the peripheral wall of the cylindrical body 30.

As shown in FIG. 6, in the illustrated embodiment, a retaining protrusion 11c is formed on the outer side of the end of the cantilever portion 11a, which is used to press against the inner wall surface of the housing 6 of the charging device to hold the elastic buckle 110 in the locked position engaged with the charging terminal 3, so that the elastic buckle 110 cannot be moved to the unlocked position detached from the charging terminal 3.

As shown in FIGS. 5-7, in the illustrated embodiment, the terminal locking component 1 further comprises a rear end wall 13 connected to the rear ends of the outer arc-shaped wall 11 and the inner arc-shaped wall 12. The rear end wall 13 and the protruding portion 11b are spaced opposite each other in the axial direction of the charging terminal 3, and the rear end wall 13 is adapted to axially rest against the rear end face of the cylindrical body 30.

As shown in FIGS. 5-7, in the illustrated embodiment, the terminal locking component 1 further includes an installation portion 14 connected to the inner arc-shaped wall 12 and the rear end wall 13, and an installation groove 140 is formed on the installation portion 14. The body 20 of the temperature sensor 2 is installed in the installation groove 140, and a pair of leads 21 of the temperature sensor 2 are led out from the rear end of the installation portion 14.

As shown in FIG. 7, in the illustrated embodiment, the mounting groove 140 of the mounting portion 14 has a side opening 14a facing the peripheral wall of the cylindrical body 30 of the charging terminal 3, and a part of the body 20 of the temperature sensor 2 is exposed through the side opening 14a for detecting the temperature of the charging terminal 3.

As shown in FIG. 6, in the illustrated embodiment, a part of the body 20 of the temperature sensor 2 is exposed through the side opening 14a and directly in thermal contact with the cylindrical body 30 of the charging terminal 3, so that the heat of the charging terminal 3 can be directly transferred to the body 20 of the temperature sensor 2. In another embodiment, a portion of the body 20 of the temperature sensor 2 is exposed through the side opening 14a and opposed to the peripheral wall of the cylindrical body 30 of the charging terminal 3, so that the heat of the charging terminal 3 can be transferred to the body 20 of the temperature sensor 2 through thermal convection or radiation.

As shown in FIGS. 1 and 2, in the illustrated embodiment, the terminal assembly further includes an injection seal 4. The injection seal 4 is injected to the rear end of the cylindrical body 30 of the charging terminal 3 and located in front of the temperature detection module 100, used to seal the mounting hole 60 of the housing 6. The injection material forming the injection seal 4 flows into the inner cavity of the cylindrical body 30 through the arc-shaped slot hole 31 in the rear end of the cylindrical body 30 and seals the inner cavity of the cylindrical body 30.

As shown in FIG. 1, in the illustrated embodiment, the charging terminal 3 further includes a connection end 39 connected to the rear end of the cylindrical body 30, which is used for electrical connection to a cable. In the illustrated embodiment, the connection end 39 of the charging terminal 3 is flat and suitable for welding to the cable.

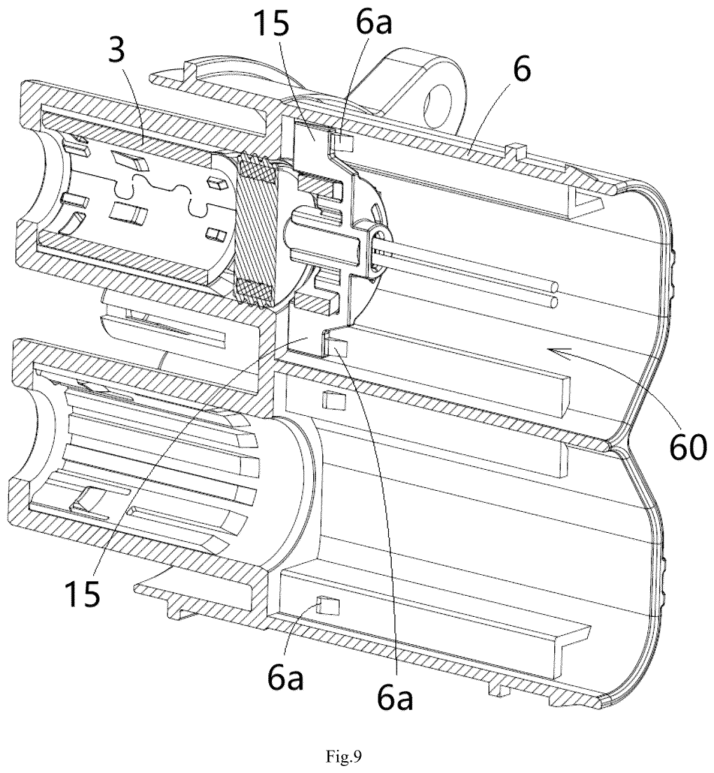

As shown in FIGS. 5 and 6, in the illustrated embodiment, an elastic locking buckle 15 is formed on the outer side of the terminal locking component 1, which is suitable for engaging with the locking protrusion 6a inside the housing 6 of the charging device to lock the terminal locking component 1 in the housing 6, as shown in FIG. 9. In the illustrated embodiment, a pair of side wing shaped elastic locks 15 are formed on the terminal locking component 1, which are suitable for engaging with a pair of locking protrusions 6a inside the housing 6 of the charging device.

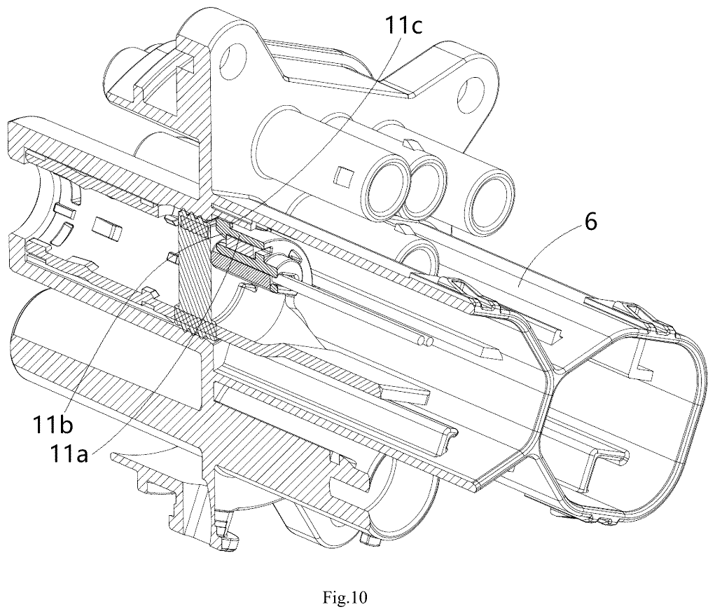

In another exemplary embodiment of the present invention, a charging device is also disclosed. The charging device comprises a housing 6, shown in FIGS. 9 and 10, and the aforementioned terminal assembly 200. Housing 6 is formed with a mounting hole 60. The terminal assembly 200 is inserted into the mounting hole 60 of the housing 6. In the illustrated embodiment, a locking protrusion 6a is formed on the inner wall of the housing 6, and the locking protrusion 6a engages with the elastic locking buckle 15 on the terminal locking component 1 to lock the terminal locking component 1 in the housing 6. In the illustrated embodiment, the charging device can be a charging dock or a charging gun.

According to another exemplary embodiment of the present invention, multiple mounting holes 60 are formed in the housing 6, and the charging device comprises multiple terminal assemblies 200 that are respectively inserted into the multiple mounting holes 60 of the housing 6.

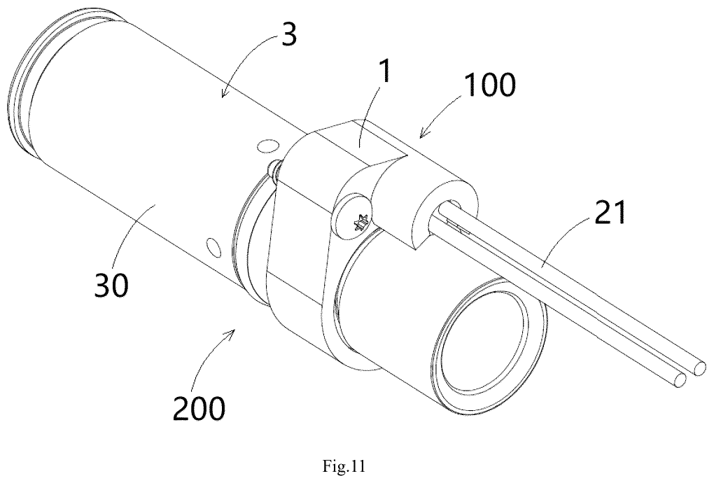

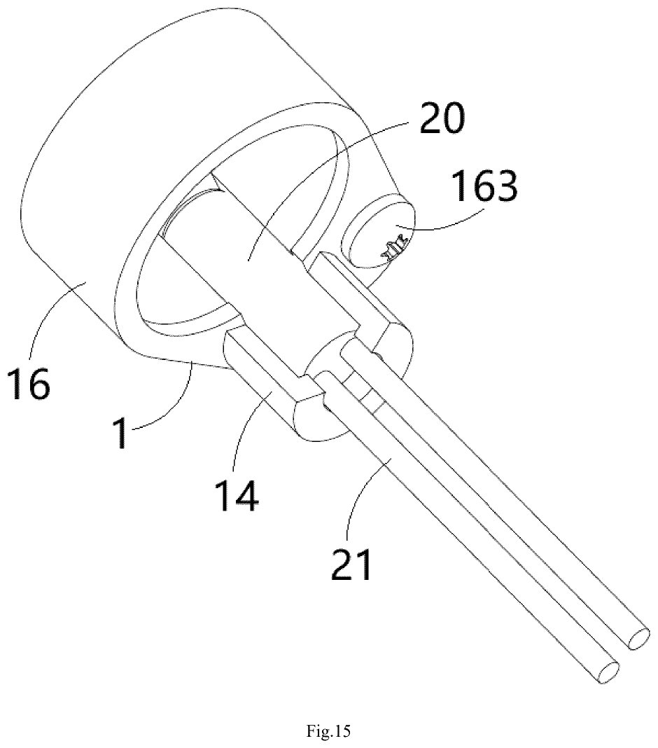

As shown in FIGS. 11 to 19, in a second exemplary embodiment of the present invention, a temperature detection module 100 is disclosed. The temperature detection module 100 includes: a terminal locking component 1 and a temperature sensor 2. The terminal locking component 1 is suitable for being installed and locked to the charging terminal 3 and for being inserted into the mounting hole 60 of the housing 6 of the charging device together with the charging terminal 3, for locking the charging terminal 3 into the housing 6. The temperature sensor 2 is installed in the terminal locking component 1 and is suitable for being inserted into the mounting hole 60 of the housing 6 together with the terminal locking component 1, for detecting the temperature of the charging terminal 3. In the illustrated embodiment, the terminal locking component 1 can be an integral injection molded part.

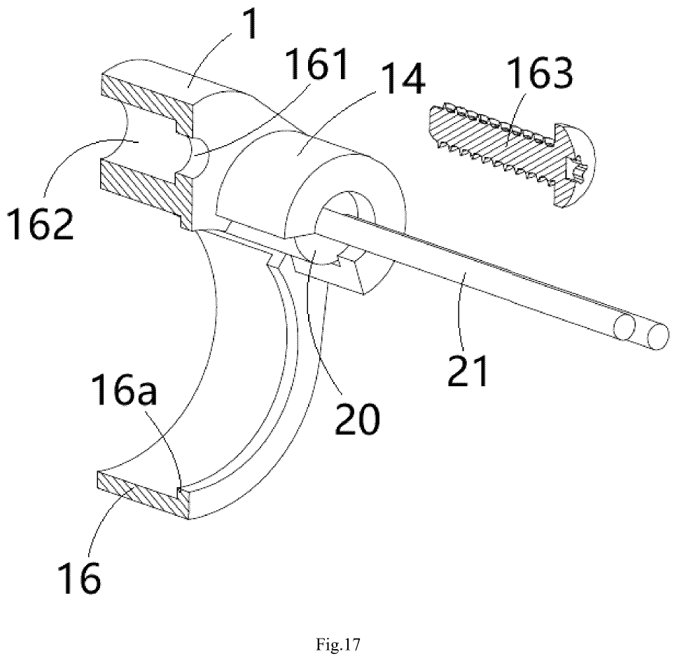

As shown in FIG. 17, in the illustrated embodiment, a connection hole 161 is formed in the terminal locking component 1 to allow the threaded connection piece 163 to pass through, and the terminal locking component 1 is adapted to be fixed to the housing 6 of the charging device through the threaded connection piece 163.

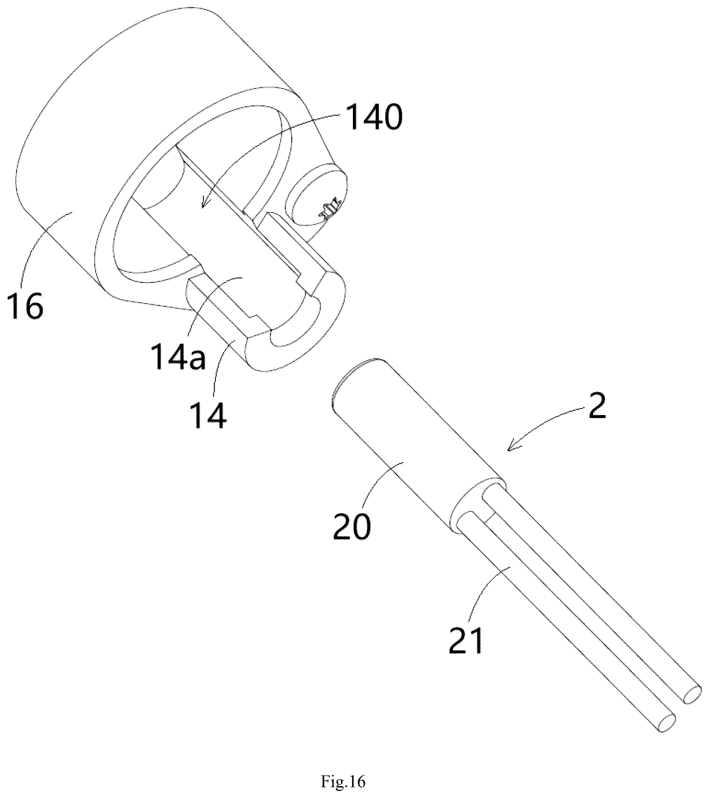

As shown in FIG. 16, in the illustrated embodiment, an installation groove 140 is formed on the terminal locking component 1, and the body 20 of the temperature sensor 2 is installed in the installation groove 140. A pair of leads 21 of the temperature sensor 2 are led out from the terminal locking component 1.

As shown in FIG. 11, in another exemplary embodiment of the present invention, a terminal assembly 200 is also disclosed. The terminal assembly 200 includes a charging terminal 3 and the aforementioned temperature detection module 100. The terminal locking component 1 of the temperature detection module 100 is installed and locked to the charging terminal 3. The terminal assembly 200 is suitable for being inserted into the mounting hole 60 in the housing 6 of the charging device, and the terminal locking component 1 is suitable for being fixed to the housing 6 to lock the charging terminal 3 in the housing 6. In the illustrated embodiment, the charging terminal 3 can be an integral machined terminal.

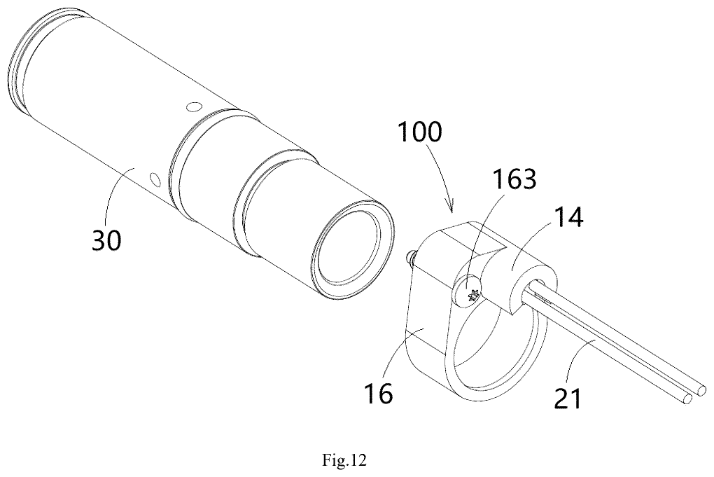

As shown in FIG. 12, in the illustrated embodiment, the charging terminal 3 comprises a cylindrical body 30, and the terminal locking component 1 comprises an annular body 16 adapted to be fitted onto the cylindrical body 30 of the charging terminal 3.

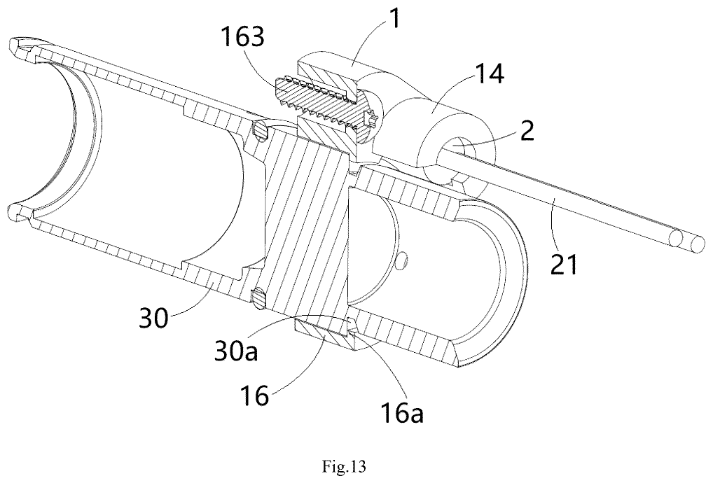

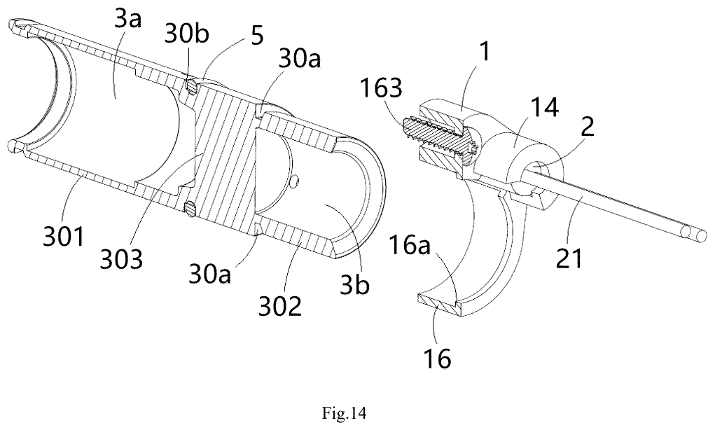

As shown in FIGS. 13 and 14, in the illustrated embodiment, an annular groove 30a is formed on the outer side of the cylindrical body 30 of the charging terminal 3, and an annular protrusion 16a is formed on the inner side of the rear end of the annular body 16 of the terminal locking component 1. The annular protrusion 16a engages with the annular groove 30a to lock the terminal locking component 1 to the cylindrical body 30 of the charging terminal 3.

As shown in FIG. 16, in the illustrated embodiment, the terminal locking component 1 further includes a mounting portion 14 formed on the annular body 16, and a mounting groove 140 is formed on the mounting portion 14. The body 20 of the temperature sensor 2 is mounted in the mounting groove 140, and a pair of leads 21 of the temperature sensor 2 are led out from the rear end of the mounting portion 14.

As shown in FIG. 16, in the illustrated embodiment, the mounting groove 140 of the mounting portion 14 has a side opening 14a facing the peripheral wall of the cylindrical body 30 of the charging terminal 3, and a part of the body 20 of the temperature sensor 2 is exposed through the side opening 14a for detecting the temperature of the charging terminal 3.

In the illustrated embodiment, a part of the body 20 of the temperature sensor 2 is exposed through the side opening 14a and directly in thermal contact with the cylindrical body 30 of the charging terminal 3, so that the heat of the charging terminal 3 can be directly transferred to the body 20 of the temperature sensor 2. In another embodiment, a portion of the body 20 of the temperature sensor 2 is exposed through the side opening 14a and opposed to the peripheral wall of the cylindrical body 30 of the charging terminal 3, so that the heat of the charging terminal 3 can be transferred to the body 20 of the temperature sensor 2 through thermal convection or radiation.

As shown in FIG. 14, in the illustrated embodiment, a sealing ring installation groove 30b is formed on the outer side of the cylindrical body 30 of the charging terminal 3, and the sealing ring installation groove 30b is located in front of the terminal locking component 1. The terminal assembly 200 also includes a sealing ring 5 installed in the sealing ring installation groove 30b, which is adapted to be radially compressed between the inner wall surface of the mounting hole 60 of the housing 6 and the cylindrical body 30 of the charging terminal 3 to achieve sealing between the two.

As shown in FIG. 14, in the illustrated embodiment, the cylindrical body 30 of the charging terminal 3 has a front chamber 3a formed in its front portion 301, a rear chamber 3b formed in its rear portion 302, and a partition 303 separating the front chamber 3a and the rear chamber 3b, so that the front chamber 3a and the rear chamber 3b are not connected. In the illustrated embodiment, the rear portion 302 of the cylindrical body 30 of the charging terminal 3 is adapted to be crimped to a cable for electrical connection with the cable.

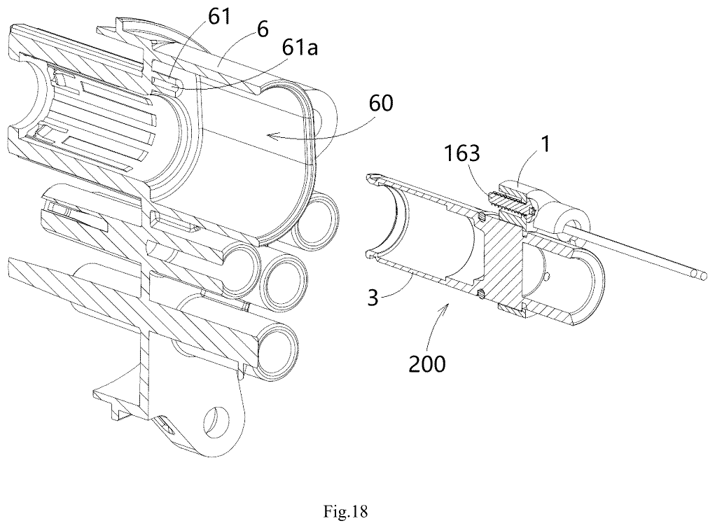

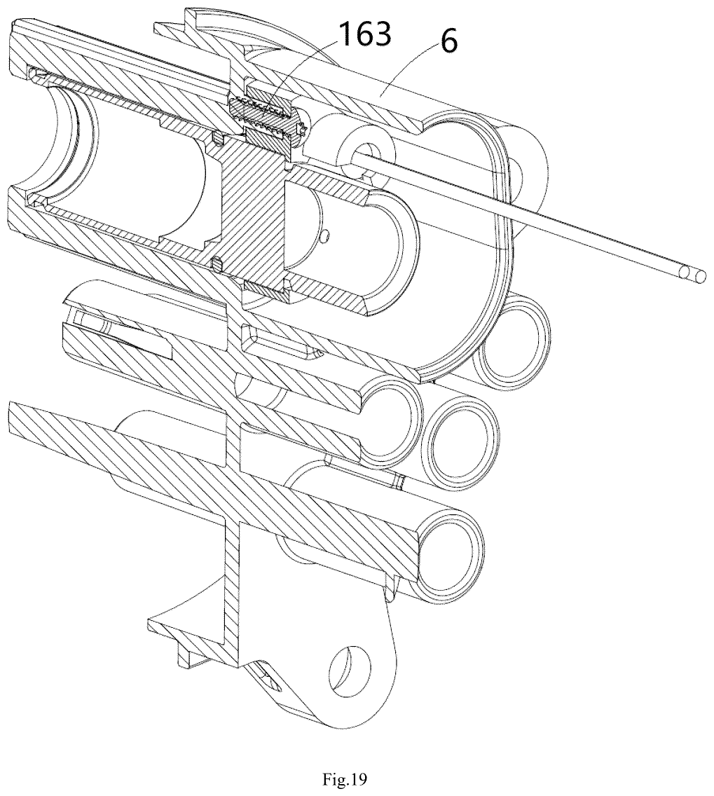

As shown in FIG. 17, in the illustrated embodiment, a connection hole 161 is formed in the terminal locking component 1 to allow the threaded connection piece 163 to pass through. The terminal locking component 1 is adapted to be fixed to the housing 6 of the charging device through the threaded connection piece 163 passing through the connection hole 161, as shown in FIGS. 18 and 19.

As shown in FIGS. 17 to 19, in the illustrated embodiment, the temperature detection module 100 further includes a threaded connection piece 163. The threaded connection piece 163 passes through the connection hole 161 in the terminal locking component 1 and is suitable for threaded connection to the housing 6 of the charging device to fix the terminal locking component 1 to the housing 6 of the charging device.

In another exemplary embodiment of the present invention, a charging device is also disclosed. The charging device comprises a housing 6, shown in FIGS. 18 and 19, and the aforementioned terminal assembly 200. Housing 6 is formed with a mounting hole 60. The terminal assembly 200 is inserted into the mounting hole 60 of the housing 6.

As shown in FIG. 18, in the illustrated embodiment, a threaded hole 61a is formed in the inner wall of the housing 6, and the threaded hole 61a is threaded with the threaded connection piece 163 passing through the connection hole 161 in the terminal locking component 1 to fix the terminal locking component 1 in the housing 6.

As shown in FIG. 17, in the illustrated embodiment, an insertion hole 162 axially connected to the connection hole 161 is formed in the terminal locking component 1, and a protruding column 61 is formed on the inner wall of the housing 6, as shown in FIG. 18. The protruding column 61 is inserted into the insertion hole 162 in the terminal locking component 1, and the threaded hole 61a is formed in the protruding column 61.

In various embodiments, the charging device can be a charging dock or a charging gun.

In the aforementioned exemplary embodiments according to the present invention, the temperature detection module can be inserted into the housing of the charging device together with the charging terminal, and the temperature detection module can also lock the charging terminal in the housing of the charging device. The installation structure of the temperature detection module of the present invention is very simple, the cost is low, and it is very convenient to use.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A temperature detection module, comprising:
a terminal locking component lockable to a charging terminal and insertable into a mounting hole of a housing of a charging device together with the charging terminal, the terminal locking component locking the charging terminal into the housing; and
a temperature sensor installed in the terminal locking component and inserted into the mounting hole of the housing together with the terminal locking component, the temperature sensor detecting a temperature of the charging terminal.

2. The temperature detection module according to claim 1, wherein the terminal locking component is an integral injection molded part.

3. The temperature detection module according to claim 1, wherein an elastic locking buckle is formed on the terminal locking component, the terminal locking component is locked into the housing of the charging device through the elastic locking buckle.

4. The temperature detection module according to claim 1, wherein a connection hole is formed in the terminal locking component and receives a threaded connection piece, the terminal locking component is fixed to the housing of the charging device through the threaded connection piece.

5. The temperature detection module according to claim 1, wherein a mounting groove is formed on the terminal locking component, a body of the temperature sensor is installed in the mounting groove, a pair of leads of the temperature sensor are led out from the terminal locking component.

6. A terminal assembly, comprising:
a charging terminal; and
a temperature detection module including a terminal locking component installed and locked to the charging terminal and a temperature sensor installed in the terminal locking component, the terminal assembly is insertable into a mounting hole in a housing of a charging device and the terminal locking component is fixed to the housing to lock the charging terminal in the housing.

7. The terminal assembly according to claim 6, wherein the charging terminal has a hollow cylindrical body, and an arc-shaped slot is formed on the terminal locking component, a part of a peripheral wall of a rear end of the hollow cylindrical body is inserted into the arc-shaped slot of the terminal locking component.

8. The terminal assembly according to claim 7, wherein an arc-shaped slot hole is formed in a peripheral wall of the rear end of the hollow cylindrical body, and an elastic buckle is formed on an outer arc-shaped wall of the terminal locking component, the elastic buckle engages with a rear edge of the arc-shaped slot hole to lock the terminal locking component to the hollow cylindrical body.

9. The terminal assembly according to claim 8, wherein the elastic buckle includes:
a cantilever portion connected to the outer arc-shaped wall; and
a protruding portion formed on the inner side of the end of the cantilever, the protruding portion of the elastic buckle is joined to the rear edge of the arc-shaped slot hole on a peripheral wall of the hollow cylindrical body.

10. The terminal assembly according to claim 9, wherein the terminal locking component has a rear end wall connected to a rear end of the outer arc-shaped wall and a rear end of an inner arc-shaped wall of the terminal locking component, the rear end wall and the protruding portion are spaced apart in an axial direction of the charging terminal, the rear end wall axially rests against a rear end face of the hollow cylindrical body.

11. The terminal assembly according to claim 10, wherein the terminal locking component has an installation portion connected to the inner arc-shaped wall and the rear end wall, and an installation groove is formed on the installation portion, a body of the temperature sensor is installed in the installation groove, and a pair of leads of the temperature sensor are led out from a rear end of the installation portion.

12. The terminal assembly according to claim 11, wherein the installation groove of the installation portion has a side opening facing a peripheral wall of the hollow cylindrical body, and a part of the body of the temperature sensor is exposed through the side opening for detecting a temperature of the charging terminal.

13. The terminal assembly according to claim 6, wherein a pair of wing shaped elastic locking buckles are formed on the terminal locking component, the pair of wing shaped elastic locking buckles engage with a pair of locking protrusions inside the housing of the charging device.

14. The terminal assembly according to claim 6, wherein the charging terminal has a cylindrical body, and the terminal locking component has an annular body adapted to be fitted onto the cylindrical body of the charging terminal.

15. The terminal assembly according to claim 14, wherein the terminal locking component has an installation portion formed on the annular body, an installation groove is formed on the installation portion, a body of the temperature sensor is installed in the installation groove and a pair of leads of the temperature sensor are led out from a rear end of the installation portion.

16. The terminal assembly according to claim 15, wherein the installation groove of the installation portion has a side opening facing a peripheral wall of the cylindrical body of the charging terminal, and a part of the body of the temperature sensor is exposed through the side opening for detecting a temperature of the charging terminal.

17. The terminal assembly according to claim 14, wherein a sealing ring installation groove is formed on an outer side of the cylindrical body of the charging terminal, the sealing ring installation groove is located in front of the terminal locking component, the terminal assembly further comprises a sealing ring installed in the sealing ring installation groove, the sealing ring is radially compressed between an inner wall surface of the mounting hole of the housing and the cylindrical body of the charging terminal to achieve sealing.

18. The terminal assembly according to claim 14, wherein the cylindrical body of the charging terminal has a front chamber formed in a front part, a rear chamber formed in a rear part, and a partition separating the front chamber and the rear chamber, the front chamber and the rear chamber are not connected.

19. The terminal assembly according to claim 6, wherein a connection hole is formed in the terminal locking component, the temperature detection module includes a threaded connection piece inserted through the connection hole and threaded into the housing to fix the terminal locking component in the housing.

20. A charging device, comprising:
a housing having a mounting hole; and
a terminal assembly inserted into the mounting hole, the terminal assembly includes a charging terminal and a temperature detection module including a terminal locking component installed and locked to the charging terminal and a temperature sensor installed in the terminal locking component, the terminal locking component is fixed to the housing to lock the charging terminal in the housing.
